(19) United States
(12) Patent Application Publication
(10) Pub. No.: US 2006/0234536 A1
(43) Pub. Date: Oct. 19, 2006

(54) SIM CARD CONNECTOR

(76) Inventors: Shih-Chung Kuan, Taipei City (TW); Yu-Fang Lin, Taipei City (TW); Cheng-Chung Chu, Taipei City (TW); Yi-Wen Wei, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,354

(22) Filed: Oct. 17, 2005

(30) Foreign Application Priority Data
Apr. 13, 2005 (TW) 94111607

(51) Int. Cl. H01R 13/62

(52) U.S. Cl. 439/159

(57) ABSTRACT

A subscriber identity module (SIM) card connector that can be embedded within a mobile communication device is provided. The SIM card connector comprises a body having an accommodating space for disposing a SIM card and multiple connected-through receptacles for receiving conducting terminals. Through the conducting terminals, an electrical signaling contact with the SIM card can be made. The connector further includes a guide arm having a first salient block and a second salient block. The first salient block and the second salient block are disposed on the respective sides of the guide arm and a cover is connected to the body for covering the accommodating space. Furthermore, the cover may connect with the guide arm through a pivot. The cover further comprises a groove. When the second salient block is moved, the first salient block shifts inside the groove and push the SIM card out from the accommodating space.

### CROSS-REFERENCE TO RELATED APPLICATION

This application claims the priority benefit of Taiwan application serial no. 94111607, filed on Apr. 13, 2005. All disclosure of the Taiwan application is incorporated herein by reference.

### BACKGROUND OF THE INVENTION

1. Field of the Invention

The present invention relates to a subscriber identity module (SIM) card connector that can be disposed inside a mobile communication device. More particularly, the present invention relates to a subscriber identity module (SIM) card connector with an ejection mechanism that can be disposed inside a mobile communication device.

2. Description of the Related Art

Through the rapid development in wireless transmission technologies, all kinds of portable electronic products are produced. One of the most common and versatile electronic products is the mobile communication device. In a mobile telephone communication system, a mobile phone number generally corresponds to a SIM card. As soon as a mobile phone user combines the SIM card with the mobile phone, the system is immediately able to identify the user, provides the kind of transmission services and gathers service data for billing purposes.

At present, most subscriber identity module (SIM) card connector utilizes the pressure exerted by an elastic plate on the SIM card to station the SIM card inside the connector. To retrieve the SIM card, the elastic plate is lifted up so that the card can be swiped or push out using a finger. However, because the hardware space occupied by the SIM card and the SIM card connector is fairly small, a user can hardly apply a direct force on the surface of the SIM card and push the SIM card out. If the user applies too large a force or submits an inappropriate force, the SIM card may be scratched or damaged. Ultimately, the operation of the SIM card may be directly affected. Furthermore, the surface of the SIM card is normally smooth. If the fingertip of user is wet and oily, there may be insufficient friction between the fingertip and the SIM card surface to move the SIM card. When this happens, auxiliary equipment may have to be secured in order to retrieve the SIM card. Thus, retrieving the SIM card is difficult and time-consuming.

Furthermore, as a result of the miniaturization of mobile phone, the SIM card connector must be easy to conceal so that a higher degree of spatial utility is obtained. Therefore, most conventional lift-top type of design can no longer meet our actual requirements.

Thus, the present invention not only provides an alternative technique, but also provides an improved design. Moreover, the present invention also provides a multiple of embodiments so that its implementation is multi-faceted and very practical.

### SUMMARY OF THE INVENTION

Accordingly, at least one objective of the present invention is to provide a subscriber identity module (SIM) card connector that allows a user to eject a SIM card directly from the connector through a second salient block. The ejection process is so smooth and easy that there is no need to apply a force directly on the SIM card and prevents the SIM card from receiving any damage.

To achieve these and other advantages and in accordance with the purpose of the invention, as embodied and broadly described herein, the invention provides a subscriber identity module (SIM) card connector that can be disposed within a mobile communication device. The SIM card connector comprises a body having an accommodating space for placing a SIM card and a plurality of connected-through receptacles for receiving a plurality of conducting terminals. Through the conducting terminals, an electrical signaling contact with the SIM card can be made. One major characteristic of the connector is that the connector further includes a guide arm having a first salient block and a second salient block. The first salient block and the second salient block are disposed on the respective sides of the guide arm and a cover is connected to the body for covering over the accommodating space. Furthermore, the cover may connect with the guide arm through a pivot. The cover further has a groove. When the second salient block is moved, the first salient block will shift inside the groove and push the SIM card out from the accommodating space.

The present invention also provide an alternative subscriber identity module (SIM) card connector that can be disposed inside a mobile communication device for holding a SIM card and forming electrical connections with the mobile communication device. The SIM card connector comprises a guide arm, a cartridge and a conducting console. The guide arm has a first salient block and a second salient block. The first salient block and the second salient block are disposed on the respective sides of the guide arm. The cartridge is connected to the guide arm through a pivot. The cartridge has a groove. When the second salient block is moved, the first salient block will shift inside the groove and push the SIM card out from the cartridge. The conducting console is set up within the cartridge and comprises a plurality of terminal accommodating receptacles and conducting terminals for electrically connecting with the SIM card.

According to the aforementioned embodiment, the guide arm has an L shape and the first salient block and the second salient block are disposed on the respective top ends of the L-shaped guide arm.

According to the aforementioned embodiment, the cartridge further comprises a body having an accommodating space for disposing the SIM card and a cover connected to the body for covering the accommodating space. In addition, the cover and the guide arm are connected through a pivot.

According to the aforementioned embodiment, the cover and the body can be connected through a latching structure.

According to the aforementioned embodiment, the body further comprises an opening capable of accommodating the conducting console.

In brief, the present invention has the following advantages over the conventional technique. The SIM card connector of the present invention eliminates the need to apply a force directly on the SIM card in order to take it out or the difficulties of removing the SIM card from inside an embedded connector and prevent the SIM card from receiving any damage. Furthermore, the present invention also includes an automatic initiating function. Hence, the present invention has great potential for future product development.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1a is a diagram showing a SIM card connector combined with a mobile phone according to one preferred embodiment of the present invention.

FIGS. 1b and 1c are locally magnified views of the structure in FIG. 1a.

FIG. 2 is a perspective view showing all the components constituting the SIM card connector according to a first preferred embodiment of the present invention.

FIG. 3 is a perspective view showing all the components constituting the SIM card connector according to a second preferred embodiment of the present invention.

FIGS. 4a through 4c are diagrams showing the mechanism of plugging and unplugging a SIM card according to the second preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

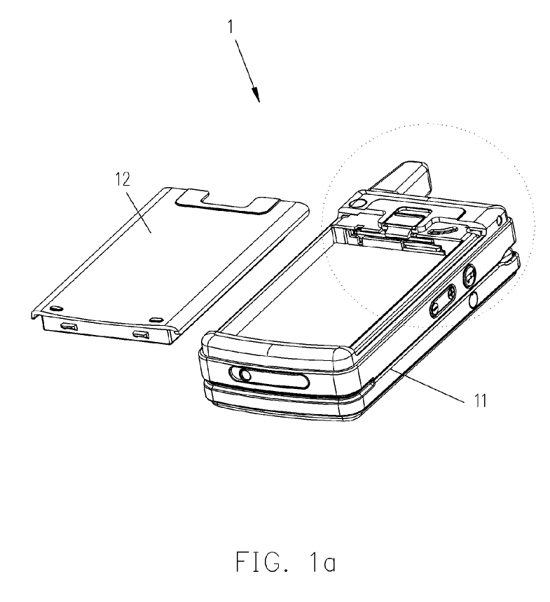

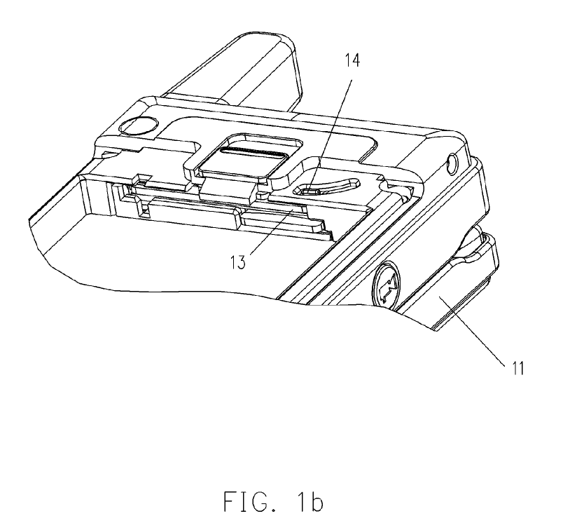

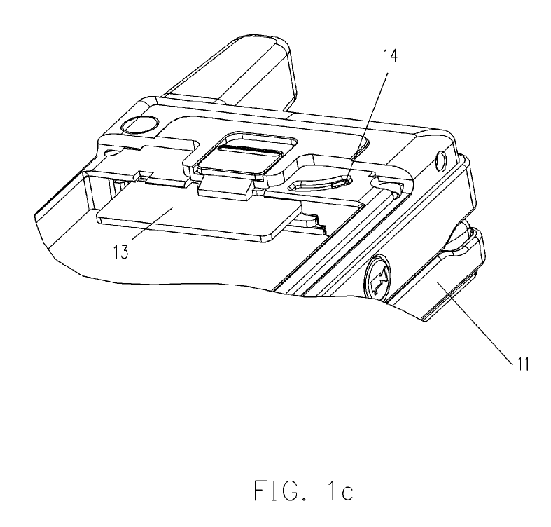

FIG. 1a is a diagram showing a SIM card connector combined with a mobile phone according to one preferred embodiment of the present invention. FIGS. 1b and 1c are locally magnified views of the structure in FIG. 1a. Due to the structural design limitation of a mobile phone, a SIM card connector must be embedded within the mobile phone 11. Moreover, the battery pack 12 needed to be taken out before the side of the SIM card 13 is exposed. Thereafter, a second salient block 14 is pushed to eject the SIM card 13 out (as shown in FIG. 1c) from the SIM card connector.

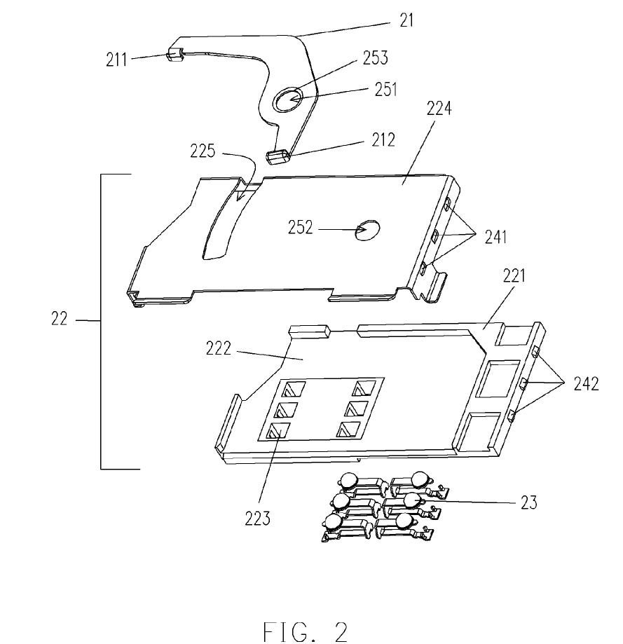

FIG. 2 is a perspective view showing all the components constituting the SIM card connector according to a first preferred embodiment of the present invention. As shown in FIG. 2, the subscriber identity module (SIM) card connector of the present invention is constructed by assembling a guide arm 21, a cartridge 22 and a plurality of conducting terminals 23 together. The guide arm 21 has a first salient block 211 and a second salient block 212. The guide arm 21 has an L shape and the first salient block 211 and the second salient block 212 are disposed at respective top ends of the guide arm 21.

The cartridge 22 comprises a body 221 having an accommodating space 222 for disposing a SIM card. The cartridge 22 also has a plurality of connected through receptacles 223 capable of inserting a plurality of conductive terminals 23. Through the conducting terminals 23, electrical signaling contact with the SIM card is possible. Furthermore, the cartridge 22 also has a cover 224 connected to the body 221 through a latching structure for covering the accommodating space 222. The latching structure refers to the holes 241 on one side of the cover 224 and their corresponding latching pegs 242 on one side of the body 221. The latching pegs 242 and the holes 241 can latch with each other so that the cover 224 and the body 221 are engaged together. In addition, the cover 224 and the guide arm 21 can be connected together through a pivot. The pivot refers to the first opening 251 on the guide arm 21 and the second opening 252 on the cover 224. The protruding edge 253 on one side of the first opening 251 may click onto the second opening 252 in the cover 224.

The cover 224 also has a groove 225. When the second salient block 212 is pushed, the first salient block 2121 will be driven inside the groove 225 to eject the SIM card from the cartridge.

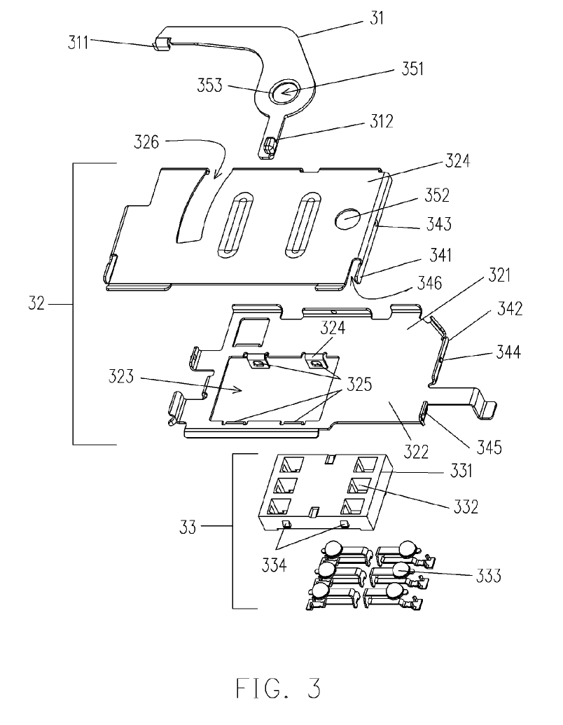

FIG. 3 is a perspective view showing all the components constituting the SIM card connector according to a second preferred embodiment of the present invention. As shown in FIG. 3, the SIM card connector comprises a guide arm 31, a cartridge 32 and a conducting console 33. The guide arm 31 has a first salient block 311 and a second salient block 312. The guide arm 31 has an L shape and the first salient block 311 and the second salient block 312 are disposed on the respective top ends of the guide arm 31.

The cartridge 32 includes a base body 321 having an accommodating space 322 for disposing a SIM card and an opening 323 for flushing in the conducting console 33. The conducting console 33 further comprises a terminal accommodating base 331 having a plurality of connected through receptacles 332 capable of inserting a plurality of conductive terminals 333. Through the conducting terminals 333, electrical signaling contact with the SIM card is possible. Furthermore, the terminal accommodating base 331 can connect the body 321 and the conducting console 33 together by clicking the latching pegs 334 on each side of the terminal accommodating base 331 into the holes 325 on the frame 324 that extends from the respective sides of the opening 323. Hence, the body 321 can connect with the conducting console 33.

The cartridge 32 further includes a cover 324 connected to the body 321 through a latching structure for covering the accommodating space 322. The latching structure refers to a first latching bar 341 located on one side of the cover 324 and a second latching bar 342 located on one side of the body 321. The latch pegs 344 on the second latching bar 342 can click into the recess holes 343 on the first latching bar 341. Furthermore, the latching portion of the second latching bar 342 may extend to the surface of the cover 324 and prop against the first latching bar 341 through the a slit at the edge next to the first latching bar 341.

Furthermore, the cover 324 can connect with the guide arm 31 through a pivot. The pivot refers to a first opening 351 located on the guide arm 31 and a second opening 352 located on the cover 324. The protruding edge 353 on one side of the first opening 351 latches with the second opening 352 on the cover 324.

The cover 324 also has a groove 325. When the second salient block 312 is pushed, the first salient block 311 will be driven inside the groove 325 to eject the SIM card from the cartridge.

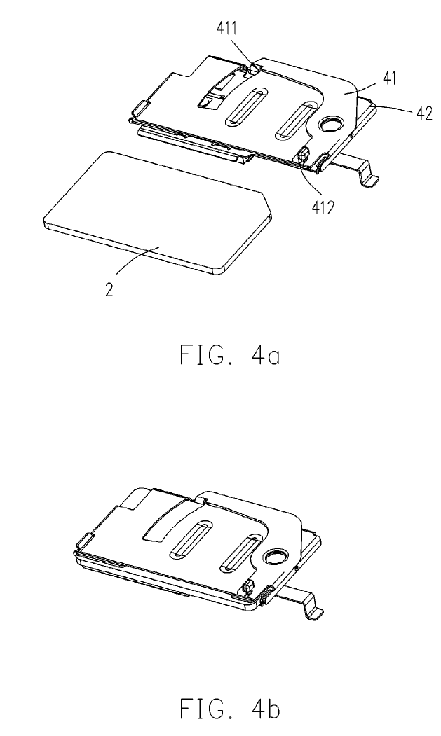

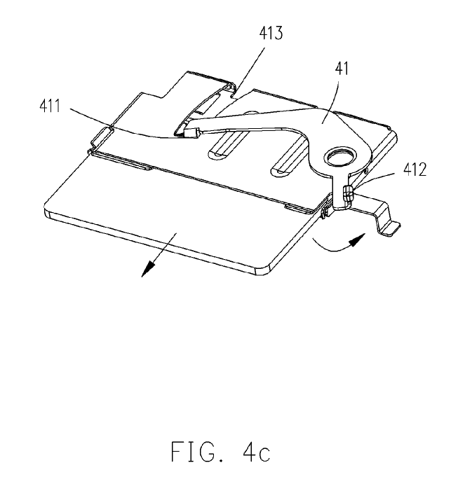

FIGS. 4a through 4c are diagrams showing the mechanism of plugging and unplugging a SIM card according to the second preferred embodiment of the present invention. Before or after inserting a SIM card 2 into the cartridge 42, there is no change to the guide arm 41. An elastic element (not shown) may also be added to the guide arm 41 according to design so that the elastic element can return the guide arm 41 to its original position after the second salient block 412 is pushed and then released. To remove the SIM card 2 from the cartridge 42, the second salient block 412 is pushed so that the first salient block 411 is driven to slide inside the groove 413 and eject the SIM card 2 from the cartridge 42. Hence, the user can easily remove the SIM card 2.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A subscriber identity module (SIM) card connector for a mobile communication device, comprising:
a body having an accommodating space for holding a SIM card and a plurality of connected-through terminal receptacles for inserting a plurality of conducting terminals such that an electrical signaling contact with the SIM card through the conducting terminals is made, the connector further comprising:
a guide arm having a first salient block and a second salient block wherein the first salient block and the second salient block are disposed on the respective sides of the guide arm; and
a cover with a groove, wherein the cover is connected to the body for covering the accommodating space and the cover and the guide arm are connected together through a pivot so that the first salient block is allowed to move within the groove, and when the second salient block is pushed, the first salient block is driven to move within the groove and eject the SIM card from the accommodating space.

2. The SIM card connector of claim 1, wherein the guide arm has an L shape and the first salient block and the second salient block are disposed on the respective top end of the L-shaped guide arm.

3. The SIM card connector of claim 1, wherein the cover and the body are connected together through a latching structure.

4. A subscriber identity module (SIM) card connector for a mobile communication device that can be used to hold a SIM card and connect the SIM card electrically with the mobile communication device, comprising:
a guide arm having a first salient block and a second salient block, wherein the first salient block and the second salient block are disposed on the respective sides of the guide arm;
a cartridge connected to the guide arm through a pivot, wherein the cartridge has a groove such that when the second salient block is pushed, the first salient block is driven to move inside the groove and eject the SIM card from the cartridge; and
a conducting console disposed inside the cartridge and comprising a plurality of terminal accommodating receptacles and conducting terminals for providing electrical connections with the SIM card.

5. The SIM card connector of claim 4, wherein the guide arm has an L shape and the first salient block and the second salient block are disposed on the respective top end of the L-shaped guide arm.

6. The SIM card connector of claim 4, wherein the cartridge further comprises:
a body having an accommodating space for holding the SIM card; and
a cover connected to the body for covering the accommodating space, wherein the cover and the guide arm are connected through a pivot.

7. The SIM card connector of claim 6, wherein the cover and the body are connected through a latching structure.

8. The SIM card connector of claim 6, wherein the body further has an opening for accommodating the conducting console.
